(19) United States
(12) Patent Application Publication
(10) Pub. No.: US 2022/0088467 A1
(43) Pub. Date: Mar. 24, 2022

(54) ACTION-SPORTS RAMP HAVING TEXTURED, PAPER-BASED SURFACE

(71) Applicant: RAINIER PLYWOOD COMPANY, Tacoma, WA (US)

(72) Inventors: Rodney Baum, Tacoma, WA (US); Don Atkinson, Tacoma, WA (US)

(21) Appl. No.: 17/477,259

(22) Filed: Sep. 16, 2021

Related U.S. Application Data
(60) Provisional application No. 63/080,534, filed on Sep. 18, 2020.

(51) Int. Cl. A63C 19/10; B32B 3/30; B32B 3/14; B32B 1/00; B32B 29/00; B32B 29/06; E01C 13/00

(52) U.S. Cl. CPC A63C 19/10; B32B 3/30; B32B 3/14; B32B 1/00; B32B 2260/046; B32B 29/06; E01C 13/003; B32B 2250/26; B32B 2260/028; B32B 29/005

(57) ABSTRACT

An action-sports ramp having a substantially rigid panel and a support structure. The substantially rigid panel includes multiple layers of cured, resin-saturated paper. An outermost layer of the layers of paper has texturing. The panel forms a sloping surface. The support structure is configured to support an action-sports rider and to support the panel at a side of the panel opposite the outermost layer.

### CROSS-REFERENCES TO RELATED APPLICATIONS

This patent application claims the benefit of U.S. Provisional Patent Application No. 63/080,534, filed Sep. 18, 2020, which is incorporated into the present disclosure by this reference.

### TECHNICAL FIELD

The subject matter is related to a system and methods for providing surfaces for action-sports ramps, such as skate park ramps and mountain biking ramps.

### BACKGROUND

Action-sports ramps are ramps used by, as examples, riders of skate boards; bicycles, including mountain bikes and BMX bikes; scooters; rollerblades; roller skates; caster boards (rip sticks); or other such action sports where a human rider rides a device that rolls on wheels, casters, rollers, or the like, whether used indoors or outdoors. Such ramps may be used by action-sports riders to, for example, perform tricks, jumps, or other desired maneuvers, including navigating the ramp as an obstacle (such as by moving on or over the ramp).

Configurations of the disclosed technology address shortcomings in the prior art.

### BRIEF DESCRIPTION OF THE DRAWINGS

FIG. 1 is an illustration of an example action-sports ramp, according to an example configuration.

FIG. 2 is a detailed view of a portion of an example panel of the action-sports ramp of FIG. 1, according to embodiments.

FIG. 3 is a detailed view of a portion of an example panel, showing example layers of the panel being stacked to form a panel.

FIG. 4 is an illustration of an example action-sports ramp, according to an example configuration where the panels of the ramp are supported by a wall.

FIG. 5 is an illustration of an example action-sports ramp, according to an example configuration where the panels of the ramp are supported by an embankment.

FIG. 6 is an illustration of an example action-sports ramp, according to an example configuration.

### DETAILED DESCRIPTION

As described herein, aspects are directed to an action-sports ramp having a textured, paper-based surface.

In configurations, the textured surface provides improved traction for users of the action-sports ramp as compared to a surface with no texturing. In configurations, the texturing results in less contact area of the ramp's surface (as compared to an surface with no texturing) interacting with the action-sports rider's equipment, such as the rider's skateboard wheels or mountain bicycle wheels. In general, the less surface area contacting the action-sports rider's wheel, for example, the faster the action-sports rider's speed. Accordingly, the reduced contact area may lead to increased speed for the action-sports rider, which can be desirable. In configurations, the textured surface retains sufficient traction, even in situations where the surface may be dusted with sawdust, dirt, or similar materials because the texturing may extend through the layer of sawdust, dirt, etc. to nevertheless contact the action-sports rider's equipment.

In configurations, the surface requires little, if any, upkeep and rarely, if ever, needs to be swept, mopped, or otherwise cleaned.

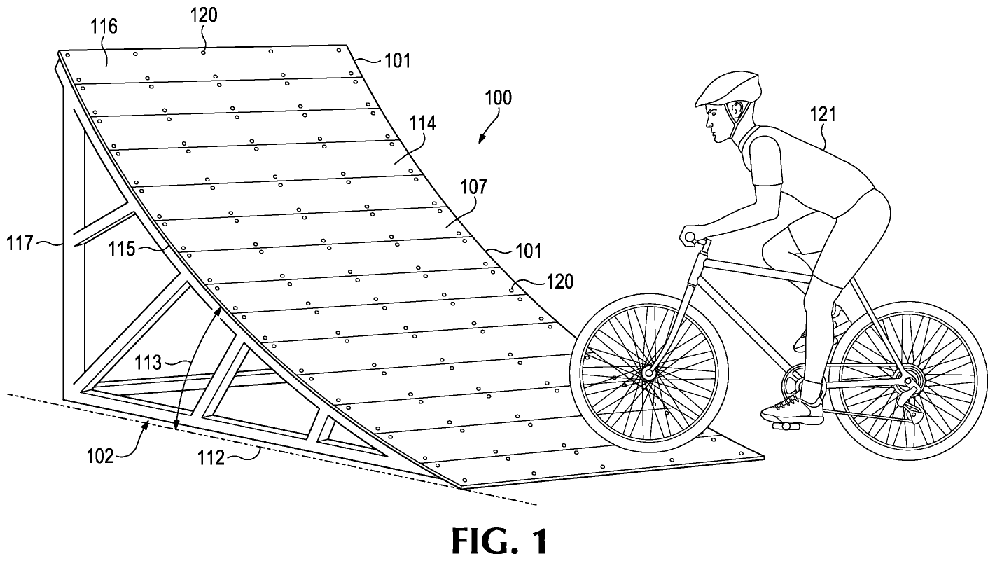

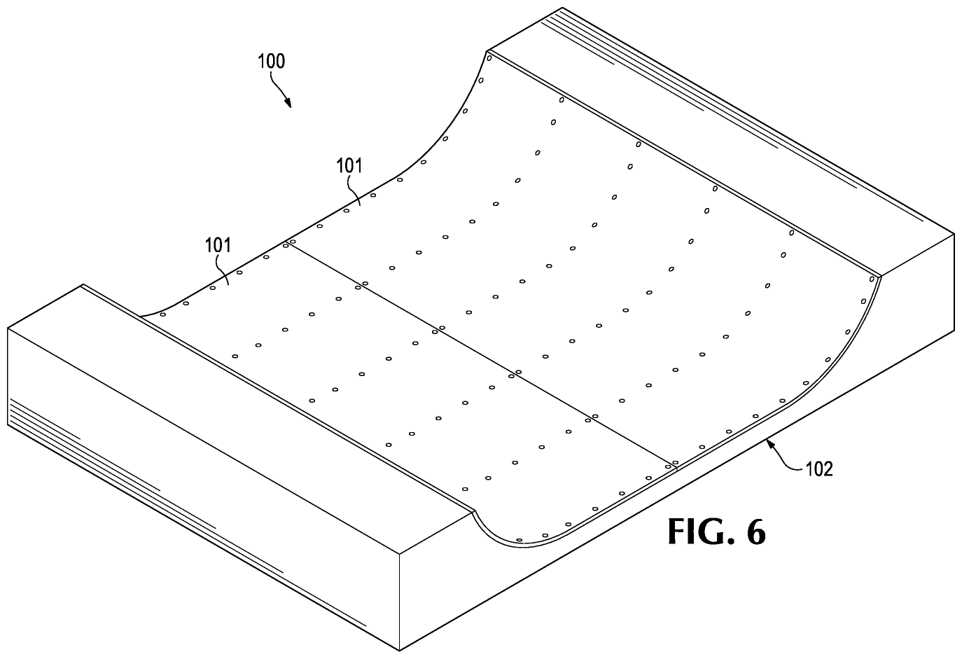

FIG. 1 is an illustration of an example action-sports ramp 100 according to an example configuration and illustrating an example of an action-sports rider 121 using the action-sports ramp 100 as a mountain bike ramp. As noted above, action-sports ramp 100 could be a skate board ramp; bicycle ramp; scooter ramp; rollerblade ramp; roller skate ramp; caster board (i.e. rip stick) ramp; or a ramp for other such action sports where a human rider rides a device that rolls on wheels, casters, rollers, or the like, whether used indoors or outdoors. FIG. 6 is an illustration of an example action-sports ramp 100 according to an example configuration where the action-sports ramp 100 is a skate-park ramp.

As illustrated in FIGS. 1 and 6, an action-sports ramp 100 may include one or more panels 101 and a support structure 102. In configurations, the action-sports ramp 100 includes multiple panels 101, such as illustrated in FIG. 1, and in other configurations, the action-sports ramp 100 includes a single panel 101. It is further noted that the panels 101 illustrated in FIG. 1 are examples, and other configurations of the panels 101, such as the configuration shown in FIG. 6, may include panels that are wider, narrower, longer, or shorter than the panels 101 illustrated in FIG. 1.

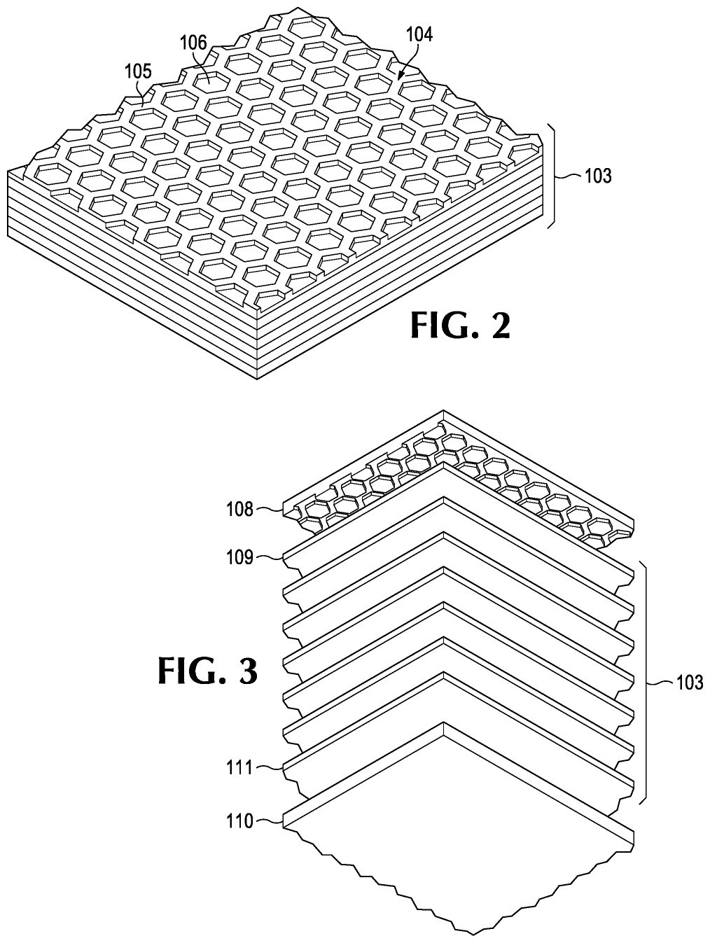

FIG. 2 is a detailed view of a portion of an example panel 101, according to embodiments. The panels 101 are substantially rigid. As used in this disclosure, “substantially rigid” means largely or essentially stiff and not pliant, without requiring perfect inflexibility. Each panel 101 includes multiple layers 103 of a cured, resin-saturated paper. The resin may be natural resin or synthetic resin, such as phenolic resin.

The outermost layer 109 has texturing 104. The texturing 104 has a tactile quality. In configurations, the texturing 104 is or includes an arrangement of ridges 105, or raised areas, and valleys 106, or depressions. In configurations, the texturing 104 is or includes a repeating pattern of hexagonal ridges 105 surrounding hexagonal valleys 106, an example of which is shown in FIG. 2. While hexagons are illustrated in the drawings, other shapes, including diamonds, squares, and circles as examples, could also be used.

In configurations, the texturing 104 substantially covers the sloping surface 107 (discussed below) of the panel 101. As used in this context, “substantially covers” means largely or essentially extends over the entirety of.

FIG. 3 illustrates a portion of an example panel 101, showing example layers 103 being stacked to form the panel 101. As shown in FIG. 3, multiple layers 103 of paper are stacked. The paper may be the type of paper known as saturating paper. In configurations, the saturating paper may be, for example, thirty-five to ninety-five pound paper (U.S. basis weight), although other weights could be suitable in some configurations. Although FIG. 3 shows seven layers 103 of paper, any number of layers could be used. As examples, configurations may have two layers, six layers, ten layers, twenty-four layers, fifty layers, or more than fifty layers of resin-saturated paper.

Before positioning into layers 103 as illustrated in FIG. 3, the paper is saturated with resin. For example, resin may be forced into the paper by running the paper through squeeze rollers, utilizing processes known in the art. In configurations, the saturation level of the resin in the paper is such that the saturated paper is about 30% to 75% paper with the remainder being resin. In other configurations, higher or lower percentages of paper may also be used.

As illustrated in FIG. 3, a first release paper 108 is against the outermost layer 109 indicated in FIG. 3. The first release paper 108 incorporates a “negative” of the desired texturing 104. In other words, where a ridge is desired in the outermost layer 109, there is a valley in the first release paper 108. Likewise, where a valley is desired in the outermost layer 109, there is a ridge in the first release paper 108. The first release paper 108 may be a silicone release paper. A second release paper 110 is against a bottom layer 111, from the perspective shown in FIG. 3. In configurations, the second release paper 110 incorporates a “negative” of the texturing 104 to be applied to the bottom layer 111. In other configurations, no texturing 104 is applied to the bottom layer 111.

Once positioned in layers 103, a hydraulic press and hot steam, as examples, may be used to process the layers 103 under heat and pressure, utilizing processes known in the art. Under heat and pressure, the first release paper 108 permanently presses the desired texturing 104 into the outermost layer 109. In configurations where texturing 104 is also desired on the bottom layer 111, the second release paper 110 likewise permanently presses the desired texturing 104 into the bottom layer 111. After processing under heat and pressure, the fully cured layers 103 form a substantially rigid, homogenous panel, with the outermost layer 109 having texturing 104 (and, perhaps, the bottom layer 111 also having texturing 104 as noted above).

Returning to FIG. 1, in configurations having multiple panels 101, the plurality of panels 101 collectively form a sloping surface 107, an example of which is shown in FIG. 1. In configurations having a single panel 101, the panel 101 forms a sloping surface 107, similar to what is shown in FIG. 1 for a multiple panel 101 configuration. For example, many action sports involve elevating a user, such as an action-sports rider 121, above the ground level. Accordingly, the action-sports ramp 100 may be positioned on the ground or another support surface, such as in the example manner illustrated in FIG. 1. The ground or other support surface is the relative datum line or datum plane that this description uses as a reference to explain certain features of the action-sports ramp 100. The sloping surface 107, then, is a positive change in angle from the line or plane defined by the datum 112. An example of this angle 113 is illustrated in FIG. 1. As illustrated in FIG. 1, a substantial majority of the sloping surface 107 extends away (particularly vertically away) from the datum 112, and it does not just lie on or along the datum 112. As used in this context, “substantial majority” means considerably more than half.

In configurations, the sloping surface 107 forms an arcuate operating surface 114. As used in this disclosure, “operating surface” means the surface upon which the action-sports rider 121 would ride. It is the surface that would contact the action-sports rider 121's wheels, for example. The arcuate surface, then, provides a curved surface for the action-sports rider 121 to navigate or use to perform desired maneuvers. As illustrated in FIG. 1, the arcuate operating surface 114 may be substantially coextensive with the sloping surface 107. As used in this disclosure, “substantially coextensive” means largely or essentially coinciding in space, without requiring perfect coincidence. In other words, the arcuate operating surface 114 portion of the sloping surface 107 may extend across substantially all of the sloping surface 107. Some configurations of the sloping surface 107 do not have arcuate portions and are substantially flat. As used in this disclosure, “substantially flat” means largely or essentially flat, without requiring perfect flatness.

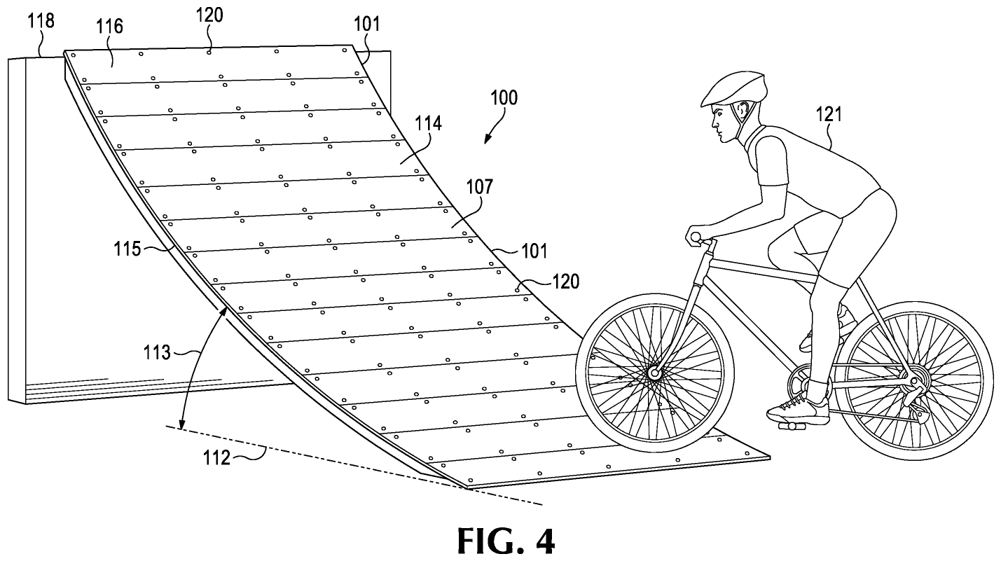

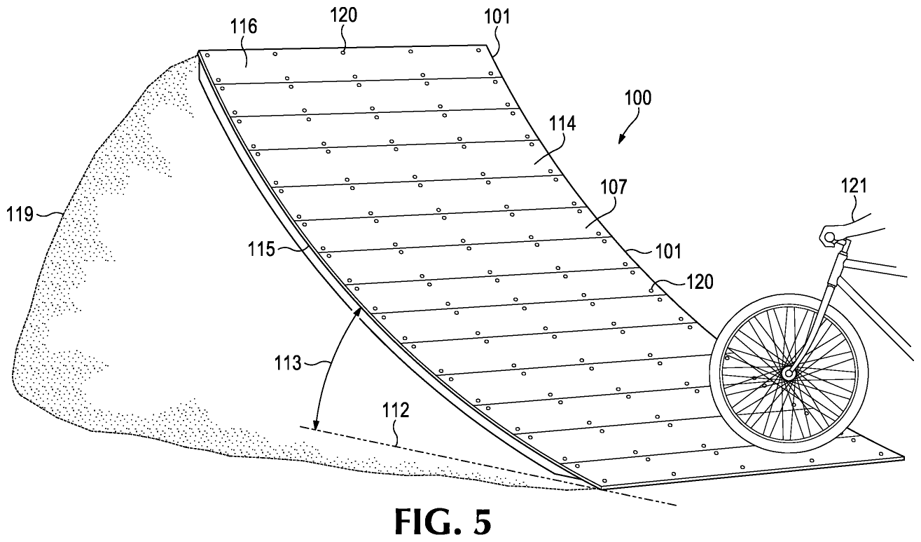

The support structure 102 is configured to support an action-sports rider 121 as well as the panels 101. In configurations, the support structure 102 supports the panels 101 at a side 115 of the panel 101 that is opposite the outermost layer 109. In that way, the side 116 of the panel 101 having the texturing 104 is available as an operating surface. The support structure 102 could be, as examples, a framework 117 (an example of which is illustrated in FIG. 1), a wall 118 (an example of which is illustrated in FIG. 4), or an embankment 119 (an example of which is illustrated in FIG. 5). With regard to the term “support structure,” the applicant intends to encompass within that term language any structure presently existing or developed in the future that performs the same function of supporting an action-sports rider 121 as well as the panels 101.

In configurations having multiple panels 101, each panel 101 of the plurality of panels 101 may be separately coupled to the support structure 102 by fasteners 120. In configurations having a single panel 101, the single panel 101 may similarly be fastened to the support structure 102.

While this disclosure is principally directed to use of the described panels 101 to construct an action-sports ramp 100, it is contemplated that the panels 101 could be used to construct an action-sports surface that does not function as a ramp, including a riding surface that is not sloping. In addition, configurations may include a lead-up to the ramp, such as the ramp illustrated in FIG. 1, where the lead-up (constructed from one or more panels 101, as described above) is a substantially flat riding surface that is also not sloping. Furthermore, configurations may include multiple ramps, whether or not joined by a riding surface (constructed from one or more panels 101, as described above) between the ramps.

### EXAMPLES

Illustrative examples of the disclosed technologies are provided below. A particular configuration of the technologies may include one or more, and any combination of, the examples described below.

Example 1 includes an action-sports ramp comprising: a substantially rigid panel comprising multiple layers of cured, resin-saturated paper, an outermost layer of the layers of cured, resin-saturated paper having texturing, the panel forming a sloping surface; and a support structure configured to support an action-sports rider and to support the panel at a side of the panel opposite the outermost layer.

Example 2 includes the action-sports ramp of Example 1, in which the sloping surface forms an arcuate operating surface.

Example 3 includes the action-sports ramp of any of Examples 1-2, in which the texturing comprises an arrangement of ridges and valleys.

Example 4 includes the action-sports ramp of any of Examples 1-3, in which the texturing comprises a repeating pattern of hexagonal ridges surrounding hexagonal valleys.

Example 5 includes the action-sports ramp of any of Examples 1-4, in which the texturing substantially covers the sloping surface of the panel.

Example 6 includes the action-sports ramp of any of Examples 1-5, in which the action-sports ramp is positioned on a datum, a substantial majority of the sloping surface extending vertically above the datum.

Example 7 includes an action-sports ramp comprising: a plurality of substantially rigid panels, each panel of the plurality of panels comprising multiple layers of cured, resin-saturated paper, an outermost layer of the layers of cured, resin-saturated paper having texturing, the plurality of panels collectively forming a sloping surface; and a support structure configured to support an action-sports rider and to support the plurality of panels at a side of the plurality of panels opposite the outermost layer of each panel of the plurality of panels.

Example 8 includes the action-sports ramp of Example 7, in which the sloping surface forms an arcuate operating surface.

Example 9 includes the action-sports ramp of any of Examples 7-8, in which the texturing comprises an arrangement of ridges and valleys.

Example 10 includes the action-sports ramp of any of Examples 7-9, in which the texturing comprises a repeating pattern of hexagonal ridges surrounding hexagonal valleys.

Example 11 includes the action-sports ramp of any of Examples 7-10, in which the texturing substantially covers the sloping surface of the panel.

Example 12 includes the action-sports ramp of any of Examples 7-11, in which the action-sports ramp is positioned on a datum, a substantial majority of the sloping surface extending vertically above the datum.

Example 13 includes the action-sports ramp of any of Examples 7-12, in which each panel of the plurality of panels is separately fastened to the support structure.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the action-sports ramp may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

I (or we) claim:

1. An action-sports ramp comprising:
a substantially rigid panel comprising multiple layers of cured, resin-saturated paper, an outermost layer of the layers of cured, resin-saturated paper having texturing, the panel forming a sloping surface; and
a support structure configured to support an action-sports rider and to support the panel at a side of the panel opposite the outermost layer.

2. The action-sports ramp of claim 1, in which the sloping surface forms an arcuate operating surface.

3. The action-sports ramp of claim 1, in which the texturing comprises an arrangement of ridges and valleys.

4. The action-sports ramp of claim 1, in which the texturing comprises a repeating pattern of hexagonal ridges surrounding hexagonal valleys.

5. The action-sports ramp of claim 1, in which the texturing substantially covers the sloping surface of the panel.

6. The action-sports ramp of claim 1, in which the action-sports ramp is positioned on a datum, a substantial majority of the sloping surface extending vertically above the datum.

7. An action-sports ramp comprising:
a plurality of substantially rigid panels, each panel of the plurality of panels comprising multiple layers of cured, resin-saturated paper, an outermost layer of the layers of cured, resin-saturated paper having texturing, the plurality of panels collectively forming a sloping surface; and
a support structure configured to support an action-sports rider and to support the plurality of panels at a side of the plurality of panels opposite the outermost layer of each panel of the plurality of panels.

8. The action-sports ramp of claim 7, in which the sloping surface forms an arcuate operating surface.

9. The action-sports ramp of claim 7, in which the texturing comprises an arrangement of ridges and valleys.

10. The action-sports ramp of claim 7, in which the texturing comprises a repeating pattern of hexagonal ridges surrounding hexagonal valleys.

11. The action-sports ramp of claim 7, in which the texturing substantially covers the sloping surface of the panel.

12. The action-sports ramp of claim 7, in which the action-sports ramp is positioned on a datum, a substantial majority of the sloping surface extending vertically above the datum.

13. The action-sports ramp of claim 7, in which each panel of the plurality of panels is separately fastened to the support structure.
